(19) United States
(12) Patent Application Publication
(10) Pub. No.: US 2021/0186802 A1
(43) Pub. Date: Jun. 24, 2021

(54) FOOT MASSAGE APPARATUS

(71) Applicant: XIAMEN COMFIER TECHNOLOGY CO., LTD., Xiamen (CN)

(72) Inventors: Jianqing Li, Xiamen (CN); Song Yang, Xiamen (CN); Lei Leng, Xiamen (CN)

(21) Appl. No.: 17/114,449

(22) Filed: Dec. 7, 2020

(30) Foreign Application Priority Data
Dec. 19, 2019 (CN) 201922292261.6

(51) Int. Cl. A61H 23/02

(52) U.S. Cl. CPC A61H 23/0254; A61H 2205/12; A61H 2201/14; A61H 2201/1215

(57) ABSTRACT

A foot massage apparatus includes a housing assembly, a driving mechanism, a front rotating member, a middle rotating member, and a rear rotating member. The middle rotating member is provided with a pivot shaft. An upper end of the pivot shaft is connected with a middle massage head. A lower end of the pivot shaft is provided with an elastic member. When different users use the foot massage apparatus, the middle massage head driven by the pivot shaft can be always in contact with the user's arch for massage. Therefore, the foot massage apparatus can meet the use requirements of different users, and make the user comfortable for massage.

### BACKGROUND OF THE INVENTION

### 1. Field of the Invention

The present invention relates to a massage apparatus, and more particularly to a foot massage apparatus.

### 2. Description of the Prior Art

In these days, the work pressure of people is gradually increasing, and physical fatigue is also gradually increasing. In order to effectively relieve the fatigue of the feet, various fatigue relief devices have been developed, and a foot massager is one of them.

After a conventional foot massage apparatus is manufactured, the difference in height between the massage heads on the foot massage apparatus will not change after being preset. However, the shape of the sole of the user's foot varies from person to person. The conventional foot massage apparatus cannot meet the needs of different users, that is, they cannot meet the needs of users with different types of feet, and thus have the defect of uncomfortable massage.

Accordingly, the inventor of the present invention has devoted himself based on his many years of practical experiences to solve these problems.

### SUMMARY OF THE INVENTION

The primary object of the present invention is to provide a comfortable foot massage apparatus, which can meet the needs of different users.

In order to achieve the above object, the present invention adopts the following technical solutions.

A foot massage apparatus comprises a housing assembly, a driving mechanism, a front rotating member, a middle rotating member, and a rear rotating member. The driving mechanism, the front rotating member, the middle rotating member and the rear rotating member are accommodated in the housing assembly. The driving mechanism drives the front rotating member, the middle rotating member and the rear rotating member to rotate. The front rotating member is connected with a front massage head. The rear rotating member is connected with a rear massage head. The middle rotating member is provided with a pivot shaft that can move up and down. An upper end of the pivot shaft is connected with a middle massage head. A lower end of the pivot shaft is provided with an elastic member. The front massage head, the middle massage head and the rear massage head rotatably extend out of the housing assembly.

Preferably, a middle portion of the middle rotating member is provided with a shaft room. A cover plate is fixedly connected to an underside of the middle rotating member. The cover plate is provided with an accommodating room. The pivot shaft is disposed in the shaft room. The lower end of the pivot shaft presses the elastic member into the accommodating room.

Preferably, at least one side of the upper end of the pivot shaft is formed with a flat surface. An end portion of the pivot shaft, located at an end of the flat surface, selectively abuts against a top inner wall of the shaft room.

Preferably, the driving mechanism includes a main worm wheel, a secondary worm wheel, and a motor having a worm. The main worm wheel and the secondary worm wheel are coaxially arranged one on top of another. The worm meshes with the main worm wheel through teeth. A side wall of the front rotating member, a side wall of the middle rotating member and a side wall of the rear rotating member are formed with teeth, respectively. The teeth of the middle rotating member mesh with the teeth of the secondary worm wheel. The teeth of the middle rotating member also mesh with the teeth of the front rotating member and the teeth of the rear rotating member.

Preferably, the motor is electrically connected to a control circuit board. The control circuit board is provided with a plurality of buttons. The buttons extend out of the housing assembly.

Preferably, the front massage head, the middle massage head and the rear massage head each have three massage spheres that are evenly spaced apart from each other.

Preferably, an upper end face of the front massage head, an upper end face of the middle massage head and an upper end face of the rear massage head are convex curved surfaces.

Preferably, the housing assembly includes an upper cover, a middle cover, and a lower housing. The front massage head, the middle massage head and the rear massage head extend out of the middle cover at intervals. The upper cover presses the middle cover to the lower housing.

Preferably, the elastic member is a spring.

Preferably, each of the front rotating member and the rear rotating member is provided with another pivot shaft that can move up and down. An upper end of the pivot shaft of the front rotating member is connected to the front massage head. A lower end of the pivot shaft of the front rotating member and a lower end of the pivot shaft of the rear rotating member is each provided with another elastic member. An upper end of the pivot shaft of the rear rotating member is connected to the rear massage head.

After adopting the above technical solutions, through the structural design of the middle rotating member, the pivot shaft and the elastic member of the present invention, when in use, the user's arch corresponds to the position of the middle massage head of the present invention. Because the lower end of the pivot shaft of the middle rotating member is provided with the elastic member, the elastic member will be deformed to different degrees when encountering different arches of the feet of different users. Thus, when different users use the present invention, the middle massage head driven by the pivot shaft can be always in contact with the user's arch for massage. Therefore, the present invention can meet the use requirements of different users, and make the user comfortable for massage. The present invention is more suitable for different types of feet.

### BRIEF DESCRIPTION OF THE DRAWINGS

FIG. 1 is a perspective view of the present invention laid with a foot pad;

FIG. 2 is a perspective view of the present invention when the upper cover is uncovered;

FIG. 3 is a perspective view of the present invention when the upper cover and middle cover are uncovered;

FIG. 4 is an exploded view of the present invention;

FIG. 5 is a partial exploded view of the middle rotating member and the middle massage head of the present invention;

FIG. 6 is an exploded view of the middle rotating member and the middle massage head of the present invention;

FIG. 7 is a partial cutaway view of FIG. 6;

FIG. 8 is a cross-sectional view of the middle rotating member and the middle massage head of the present invention;

FIG. 9 is a first schematic view of the middle rotating member and the middle massage head of the present invention when in use; and

FIG. 10 is a second schematic view of the middle rotating member and the middle massage head of the present invention when in use.

### DETAILED DESCRIPTION OF THE PREFERRED EMBODIMENTS

Embodiments of the present invention will now be described, by way of example only, with reference to the accompanying drawings.

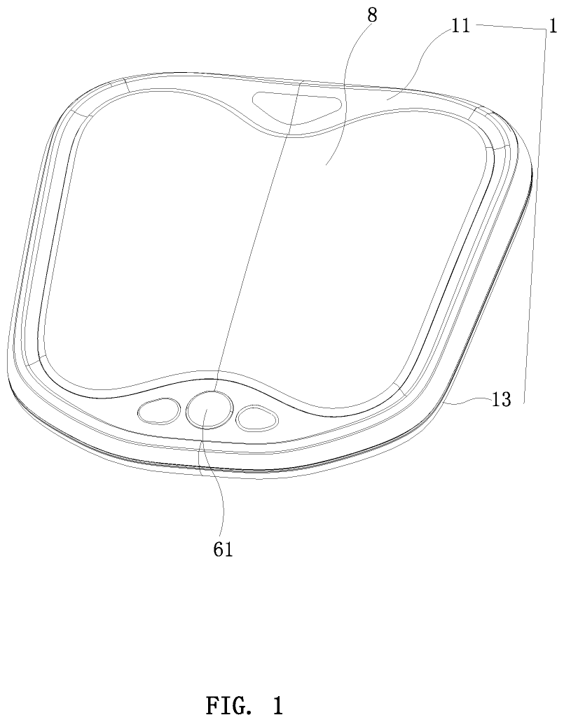

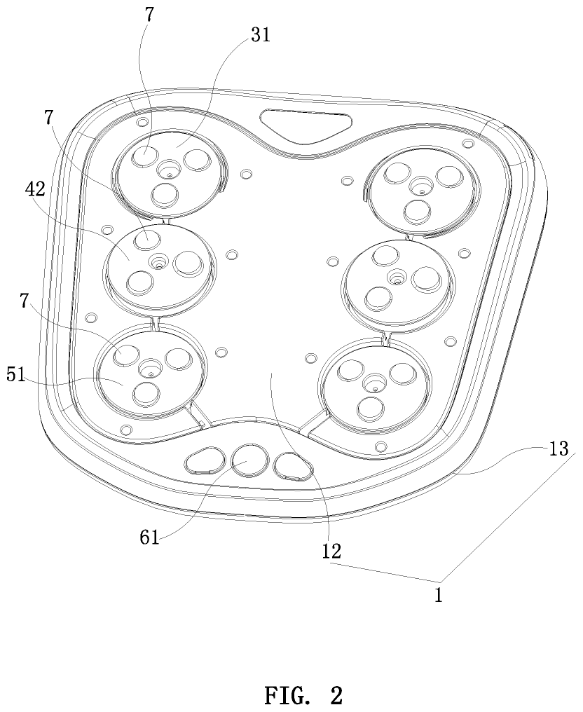

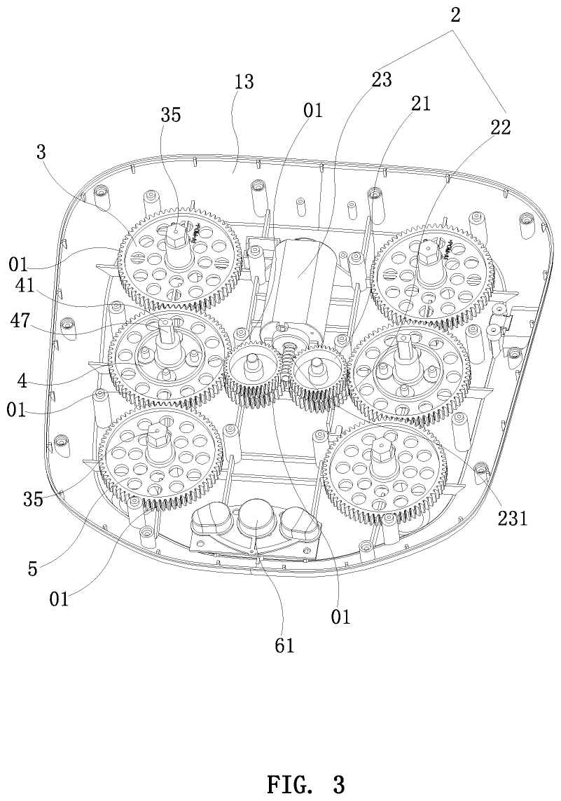

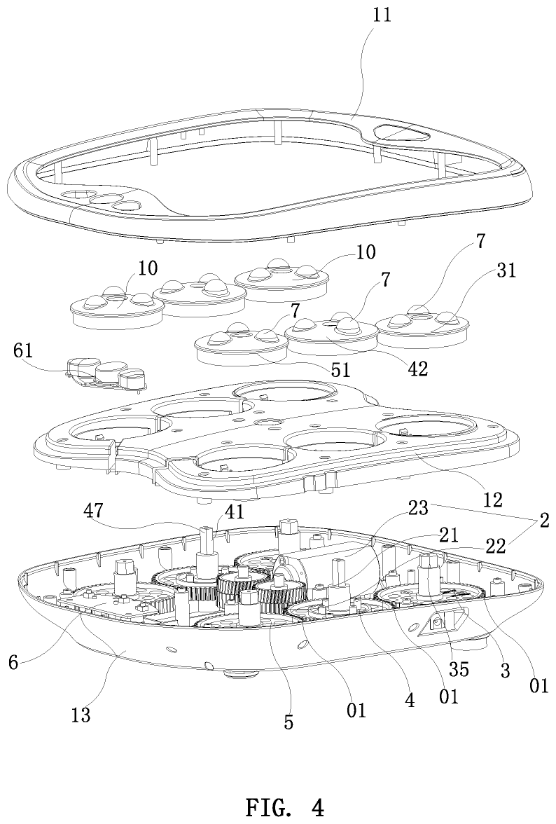

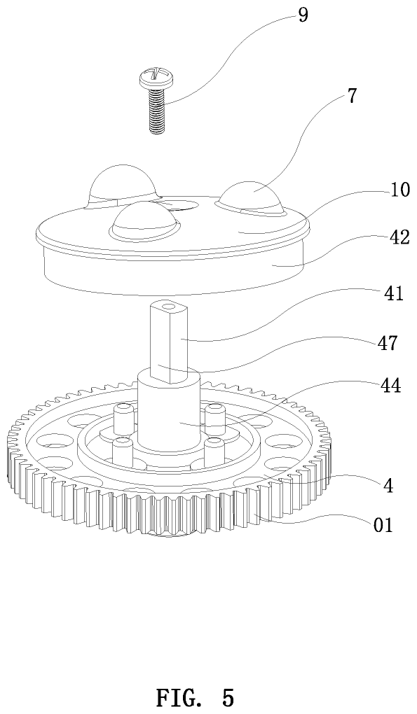

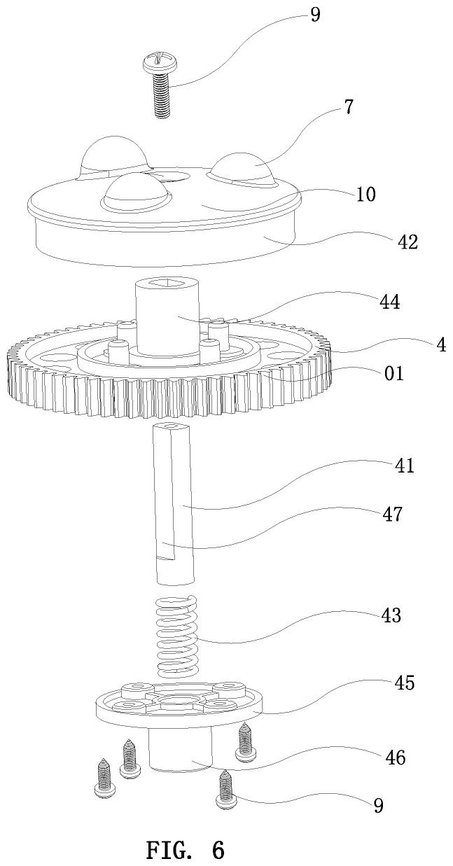

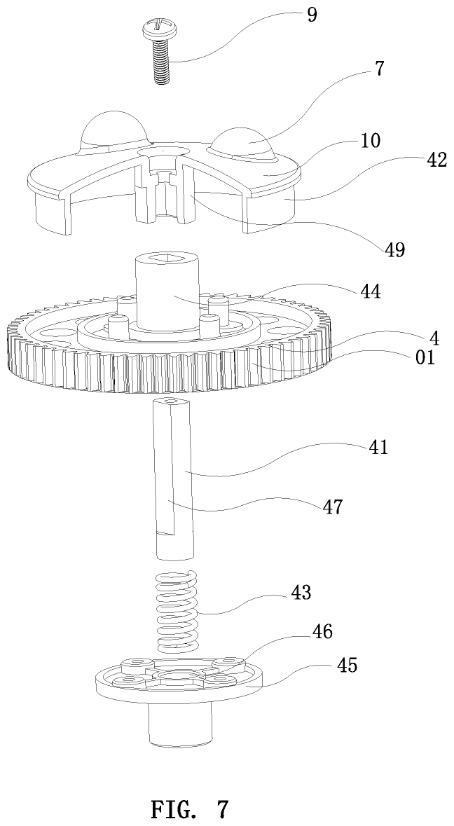

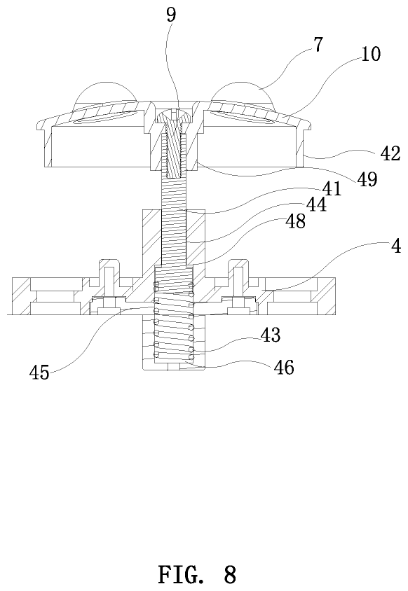

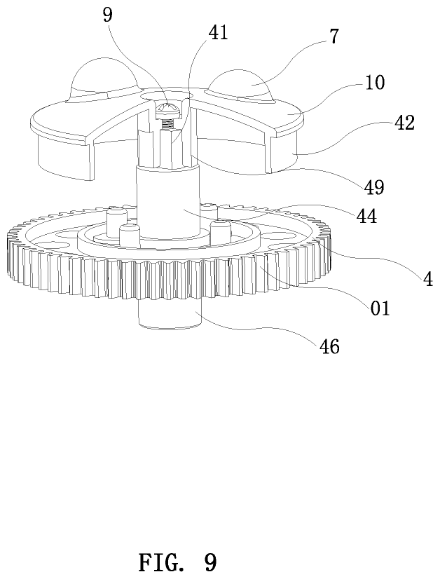

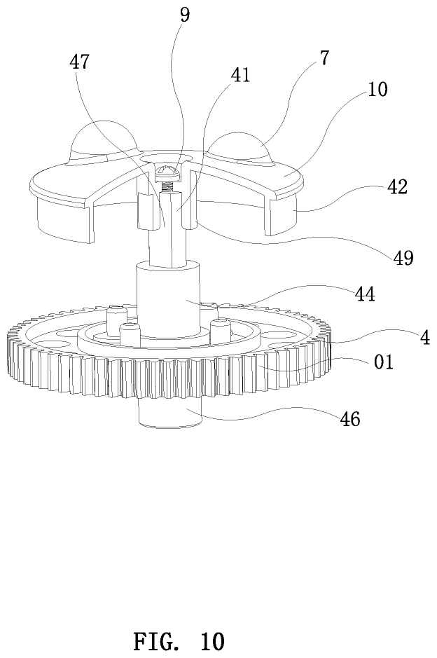

As shown in FIG. 1 through FIG. 10, the present invention discloses a foot massage apparatus, comprising a housing assembly 1, a driving mechanism 2, a front rotating member 3, a middle rotating member 4, and a rear rotating member 5. The driving mechanism 2, the front rotating member 3, the middle rotating member 4 and the rear rotating member 5 are accommodated in the housing assembly 1. The driving mechanism 2 drives the front rotating member 3, the middle rotating member 4 and the rear rotating member 5 to rotate. The front rotating member 3 is connected with a front massage head 31. The rear rotating member 5 is connected with a rear massage head 51. The middle rotating member 4 is provided with a pivot shaft 41 that can move up and down. The upper end of the pivot shaft 41 is connected with a middle massage head 42. The lower end of the pivot shaft 41 is provided with an elastic member 43. The front massage head 31, the middle massage head 42, and the rear massage head 51 rotatably extend out of the housing assembly 1. This embodiment includes a pair of front rotating members 3, a pair of middle rotating members 4 and a pair of rear rotating members 5 that are symmetrically arranged relative to the driving mechanism 2, so that the left and right feet of the user can be placed on the foot massage apparatus of the present invention for massage. The elastic member 43 may be a spring, but not limited thereto. The elastic member 43 may be other elastic components.

When in use, the user's arch corresponds to the position of the middle massage head 42 of the present invention. Because the lower end of the pivot shaft 41 of the middle rotating member 4 is provided with the elastic member 43, the elastic member 43 will be deformed to different degrees when encountering different arches of the feet of different users. The elastic member 43 is linked with the pivot shaft 41 of the middle rotating member 4 to move up and down, so that when different users use the present invention, the middle massage head 42 driven by the pivot shaft 41 can be always in contact with the user's arch for massage. Therefore, the present invention can meet the use requirements of different users, and make the user comfortable for massage. The present invention is more suitable for different types of feet.

The housing assembly 1 may include an upper cover 11, a middle cover 12, and a lower housing 13. The driving mechanism 2, the front rotating member 3, the middle rotating member 4 and the rear rotating member 5 are all accommodated inside the lower housing 13. The front massage head 31, the middle massage head 42 and the rear massage head 51 extend out of the middle cover 12 at intervals. The upper cover 11 presses the middle cover 12 to the lower housing 13. The upper cover 11 can be locked to the lower housing 13 by screws. In order to make it easier for the user to step on the foot massage apparatus, a foot pad 8 for the user to step on the foot massage apparatus can be laid on the front massage head 31, the middle massage head 42, and the rear massage head 51. The foot pad 8 is attached to the inner edge of the upper cover 11.

Furthermore, the driving mechanism 2 may include a main worm wheel 21, a secondary worm wheel 22, and a motor 23 having a worm 231. The main worm wheel 21 and the secondary worm wheel 22 are coaxially arranged one on top of another. The worm 231 meshes with the main worm wheel 21 through teeth 01. The side wall of the front rotating member 3, the side wall of the middle rotating member 4, and the side wall of the rear rotating member 5 are formed with teeth 01, respectively. The teeth 01 of the middle rotating member 4 mesh with the teeth 01 of the secondary worm wheel 22. The teeth 01 of the middle rotating member 4 also mesh with the teeth 01 of the front rotating member 3 and the teeth 01 of the rear rotating member 5. Therefore, the rotation of the motor 23 drives the middle rotating member 4 to rotate, and then the middle rotating member 4 drives the front rotating member 3 and the rear rotating member 5 to rotate. The structure of the driving mechanism 2 is not limited to the above, and a belt transmission structure or other transmission structures may be adopted.

In order to facilitate the control of the rotation of the motor 23, the motor 23 may be electrically connected to a control circuit board 6. The control circuit board 6 is provided with a plurality of buttons 61. The buttons 61 extend out of the housing assembly 1. The control circuit board 6 is selectively electrically connected to an external power source.

Furthermore, the front massage head 31, the middle massage head 42 and the rear massage head 51 each have three massage spheres 7 that are evenly spaced apart from each other. The upper end face of the front massage head 31, the upper end face of the middle massage head 42 and the upper end face of the rear massage head 51 are convex curved surfaces 10, so that the user's feet can be fully massaged.

The middle portion of the middle rotating member 4 is provided with a shaft room 44. A cover plate 45 is fixedly connected to the underside of the middle rotating member 4 by screws 9. The cover plate 45 may be provided with an accommodating room 46. The pivot shaft 41 is disposed in the shaft room 44, and the lower end of the pivot shaft 41 presses the elastic member 43 into the accommodating room 46, so as to facilitate the arrangement of the pivot shaft 41 and the elastic member 43.

At least one side of the upper end of the pivot shaft 41 may be formed with a flat surface 47. In this embodiment, the upper end of the pivot shaft 41 has two flat surfaces 47. The two flat surfaces 47 are symmetric relative to the central axis of the pivot shaft 41. The end portion of the pivot shaft 41, located at the end of the flat surface 47, selectively abuts against a top inner wall 48 of the shaft room 44. The flat surface 47 enables the middle rotating member 4 to drive the pivot shaft 41 and the middle massage head 42 to rotate. A screw 9 passes through the middle massage head 42 and is screwed to the pivot shaft 41. The lower end of the middle massage head 42 may be provided with an annular stop wall 49. The lower end of the stop wall 49 selectively abuts against the upper end of the shaft room 44, so as to limit the range of vertical movement of the pivot shaft 41.

In this embodiment, each of the front rotating member 3 and the rear rotating member 5 is provided with a pivot end 35. The pivot end 35 is connected with the front massage head 31/the rear massage head 51. The pivot end 35 is hexagonal, but not limited thereto. The front rotating member 3 and the rear rotating member 5 may have the same structure as the middle rotating member 4, that is, each of the front rotating member 3 and the rear rotating member 5 is provided with a pivot shaft 41 that can move up and down. The upper end of the pivot shaft 41 of the front rotating member 3 is connected to the front massage head 31. The lower end of the pivot shaft 41 of the front rotating member 3 and the lower end of the pivot shaft 41 of the rear rotating member 5 is each provided with an elastic member 43. The upper end of the pivot shaft 41 of the rear rotating member 5 is connected to the rear massage head 51. Therefore, the flexibility of use of the present invention is improved.

The front massage head 31 and the rear massage head 51 can also move up and down.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A foot massage apparatus, comprising a housing assembly, a driving mechanism, a front rotating member, a middle rotating member and a rear rotating member, the driving mechanism, the front rotating member, the middle rotating member and the rear rotating member being accommodated in the housing assembly, the driving mechanism driving the front rotating member, the middle rotating member and the rear rotating member to rotate, the front rotating member being connected with a front massage head, the rear rotating member being connected with a rear massage head;
the middle rotating member being provided with a pivot shaft that can move up and down, an upper end of the pivot shaft being connected with a middle massage head, a lower end of the pivot shaft being provided with an elastic member, the front massage head, the middle massage head and the rear massage head rotatably extending out of the housing assembly.

2. The foot massage apparatus as claimed in claim 1, wherein a middle portion of the middle rotating member is provided with a shaft room, a cover plate is fixedly connected to an underside of the middle rotating member, the cover plate is provided with an accommodating room, the pivot shaft is disposed in the shaft room, and the lower end of the pivot shaft presses the elastic member into the accommodating room.

3. The foot massage apparatus as claimed in claim 2, wherein at least one side of the upper end of the pivot shaft is formed with a flat surface, and an end portion of the pivot shaft, located at an end of the flat surface selectively abuts against a top inner wall of the shaft room.

4. The foot massage apparatus as claimed in claim 3, wherein the driving mechanism includes a main worm wheel, a secondary worm wheel and a motor having a worm, the main worm wheel and the secondary worm wheel are coaxially arranged one on top of another, the worm meshes with the main worm wheel through teeth, a side wall of the front rotating member, a side wall of the middle rotating member and a side wall of the rear rotating member are formed with teeth respectively, the teeth of the middle rotating member mesh with the teeth of the secondary worm wheel, the teeth of the middle rotating member also mesh with the teeth of the front rotating member and the teeth of the rear rotating member.

5. The foot massage apparatus as claimed in claim 4, wherein the motor is electrically connected to a control circuit board, the control circuit board is provided with a plurality of buttons, and the buttons extend out of the housing assembly.

6. The foot massage apparatus as claimed in claim 3, wherein the front massage head, the middle massage head and the rear massage head each have three massage spheres that are evenly spaced apart from each other.

7. The foot massage apparatus as claimed in claim 6, wherein an upper end face of the front massage head, an upper end face of the middle massage head and an upper end face of the rear massage head are convex curved surfaces.

8. The foot massage apparatus as claimed in claim 2, wherein the driving mechanism includes a main worm wheel, a secondary worm wheel and a motor having a worm, the main worm wheel and the secondary worm wheel are coaxially arranged one on top of another, the worm meshes with the main worm wheel through teeth, a side wall of the front rotating member, a side wall of the middle rotating member and a side wall of the rear rotating member are formed with teeth respectively, the teeth of the middle rotating member mesh with the teeth of the secondary worm wheel, the teeth of the middle rotating member also mesh with the teeth of the front rotating member and the teeth of the rear rotating member.

9. The foot massage apparatus as claimed in claim 8, wherein the motor is electrically connected to a control circuit board, the control circuit board is provided with a plurality of buttons, and the buttons extend out of the housing assembly.

10. The foot massage apparatus as claimed in claim 2, wherein the front massage head, the middle massage head and the rear massage head each have three massage spheres that are evenly spaced apart from each other.

11. The foot massage apparatus as claimed in claim 10, wherein an upper end face of the front massage head, an upper end face of the middle massage head and an upper end face of the rear massage head are convex curved surfaces.

12. The foot massage apparatus as claimed in claim 1, wherein the driving mechanism includes a main worm wheel, a secondary worm wheel and a motor having a worm, the main worm wheel and the secondary worm wheel are coaxially arranged one on top of another, the worm meshes with the main worm wheel through teeth, a side wall of the front rotating member, a side wall of the middle rotating member and a side wall of the rear rotating member are formed with teeth respectively, the teeth of the middle rotating member mesh with the teeth of the secondary worm wheel, the teeth of the middle rotating member also mesh with the teeth of the front rotating member and the teeth of the rear rotating member.

13. The foot massage apparatus as claimed in claim 12, wherein the motor is electrically connected to a control circuit board, the control circuit board is provided with a plurality of buttons, and the buttons extend out of the housing assembly.

14. The foot massage apparatus as claimed in claim 1, wherein the front massage head, the middle massage head and the rear massage head each have three massage spheres that are evenly spaced apart from each other.

15. The foot massage apparatus as claimed in claim 14, wherein an upper end face of the front massage head, an upper end face of the middle massage head and an upper end face of the rear massage head are convex curved surfaces.

16. The foot massage apparatus as claimed in claim 1, wherein the housing assembly includes an upper cover, a middle cover and a lower housing, the front massage head, the middle massage head and the rear massage head extend out of the middle cover at intervals, and the upper cover presses the middle cover to the lower housing.

17. The foot massage apparatus as claimed in claim 1, wherein the elastic member is a spring.

18. The foot massage apparatus as claimed in claim 1, wherein each of the front rotating member and the rear rotating member is provided with another pivot shaft that can move up and down, an upper end of the pivot shaft of the front rotating member is connected to the front massage head, a lower end of the pivot shaft of the front rotating member and a lower end of the pivot shaft of the rear rotating member is each provided with another elastic member, an upper end of the pivot shaft of the rear rotating member is connected to the rear massage head.
